(19) United States
(12) Patent Application Publication
(10) Pub. No.: US 2026/0044925 A1
(43) Pub. Date: Feb. 12, 2026

(54) Late Stage Selective Warping of a Computer-Generated Object

(71) Applicant: APPLE INC., Cupertino, CA (US)

(72) Inventors: Seyedkoosha Mirhosseini, Santa Clara, CA (US); Seyedpooya Mirhosseini, Santa Clara, CA (US); Sushant Ojal, Sunnyvale, CA (US); Tara Hariri, Cupertino, CA (US)

(21) Appl. No.: 19/282,558

(22) Filed: Jul. 28, 2025

Related U.S. Application Data
(60) Provisional application No. 63/680,213, filed on Aug. 7, 2024.

(51) Int. Cl. G06T 3/18; G06T 3/20; G06T 3/60; G06T 7/70

(52) U.S. Cl. CPC G06T 3/18; G06T 3/20; G06T 3/60; G06T 7/70; G06T 2207/30196

(57) ABSTRACT

A method is performed at a first electronic device with one or more processors, a non-transitory memory, and a display. The method includes rendering a computer-generated object at a first time. The computer-generated object is positionally dependent on a first physical object. The method includes obtaining a predicted pose of the first physical object at a second time. The second time is after the first time. The method includes warping a first portion of the computer-generated object based at least in part on a first distance between the predicted pose and the first portion. The method includes displaying, on the display at the second time, the warped first portion of the computer-generated object.

### CROSS-REFERENCE TO RELATED APPLICATIONS

This application claims priority to U.S. Provisional Patent App. No. 63/680,213, filed on Aug. 7, 2024, which is hereby incorporated by reference in its entirety.

### TECHNICAL FIELD

The present disclosure relates to systems, methods, and devices of warping a computer-generated object.

### BACKGROUND

In various implementations, an environment displayed by an electronic device includes content that is anchored to a physical object. However, movement of the physical object may introduce distortion in display of the content, due to latency between the movement and display updates performed by the electronic device.

### SUMMARY

A method is performed at a first electronic device with one or more processors, a non-transitory memory, and a display. The method includes rendering a computer-generated object at a first time. The computer-generated object is positionally dependent on a first physical object. The method includes obtaining a predicted pose of the first physical object at a second time. The second time is after the first time. The method includes warping a first portion of the computer-generated object based at least in part on a first distance between the predicted pose and the first portion. The method includes displaying, on the display at the second time, the warped first portion of the computer-generated object.

In accordance with some implementations, a first electronic device includes one or more processors, a non-transitory memory, and a display. One or more programs are stored in the non-transitory memory and are configured to be executed by the one or more processors. The one or more programs include instructions for performing or causing performance of the operations of any of the methods described herein. In accordance with some implementations, a non-transitory computer readable storage medium has stored therein instructions which when executed by one or more processors of a first electronic device, cause the device to perform or cause performance of the operations of any of the methods described herein. In accordance with some implementations, a first electronic device includes means for performing or causing performance of the operations of any of the methods described herein. In accordance with some implementations, an information processing apparatus, for use in a first electronic device, includes means for performing or causing performance of the operations of any of the methods described herein.

### BRIEF DESCRIPTION OF THE DRAWINGS

For a better understanding of the various described implementations, reference should be made to the Description, below, in conjunction with the following drawings in which like reference numerals refer to corresponding parts throughout the figures.

FIG. 1 is a block diagram of an example of a portable multifunction device in accordance with some implementations.

FIG. 2 is a block diagram of an example of an auxiliary device in accordance with some implementations.

FIG. 3 is an example of an operating environment in accordance with some implementations.

FIGS. 4A-4F are various examples of anchoring a computer-generated object to an electronic device based on movements of the electronic device in accordance with some implementations.

FIG. 5 is an example of a first electronic device in accordance with some implementations.

FIG. 6 is an example of a flow diagram of a method of anchoring a computer-generated object to a physical object based on movements of the physical object in accordance with some implementations.

### DESCRIPTION OF IMPLEMENTATIONS

In various circumstances, an extended reality (XR) environment presented by an electronic device including a display includes content that is anchored to a physical object within the XR environment. In some circumstances, the locking is dynamic, such that the device moves content on the display based on a corresponding movement of the physical object. For example, a computer-generated sword may be anchored to a physical object, and movements of the physical object cause corresponding movements of the computer-generated sword. However, movement of the physical object may introduce distortion in display of the content, due to latency between the movement and corrective action taken by the device. For example, a rotational movement of the physical object may result in display lag regarding display of the tip of the computer-generated sword, because other techniques perform a reprojection of the tip associated with a large magnitude of correction. A large magnitude of correction, associated with the reprojection, often produces display distortion.

By contrast, various implementations disclosed herein include methods, electronic devices, and systems for performing late stage selective warping of a computer-generated object that is positionally dependent on (e.g., anchored to) a physical object. Namely, a first electronic device warps different portions of a computer-generated object based on respective distances between each of the portions and a predicted pose of the physical object. For example, in some implementations, based on a rotational movement of the physical object, a first portion of the computer-generated object is a first distance from the predicted pose, and a second portion of the computer-generated object is a second distance from the predicted pose, wherein the first distance is greater than the second distance. Continuing with this example, the first electronic device warps the first portion more than the second portion, based on the first distance being greater than the second distance. To these ends, in some implementations, the first electronic device renders, at a first time, a computer-generated object, which is anchored to the physical object. The first electronic device obtains a predicted pose of the physical object at a later, second time. The predicted pose may be based on IMU data from a sensor of the physical object, or extremity tracking of a user extremity (e.g., via computer vision) that is “holding” the computer-generated object. Based on respective distances between portions of the computer-generated object and the predicted pose, the first electronic device warps the portions of the computer-generated object. Warping based on the predicted pose of the physical object at the second time enables display of the warped portions at the second time, thereby preventing display distortion. The warping may be performed later in the graphics pipeline than the rendering stage (e.g., between the rendering stage and the display stage), and thus may be characterized as late stage warping.

In some implementations, the predicted pose (and therefore warping) accounts for a translational movement and/or a rotational movement of the physical object. These two movement types may be considered independently of (e.g., decoupled from) each other. In some implementations, consideration of a movement type is based on satisfaction of a corresponding threshold.

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described implementations. The first contact and the second contact are both contacts, but they are not the same contact, unless the context clearly indicates otherwise.

The terminology used in the description of the various described implementations herein is for the purpose of describing particular implementations only and is not intended to be limiting. As used in the description of the various described implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

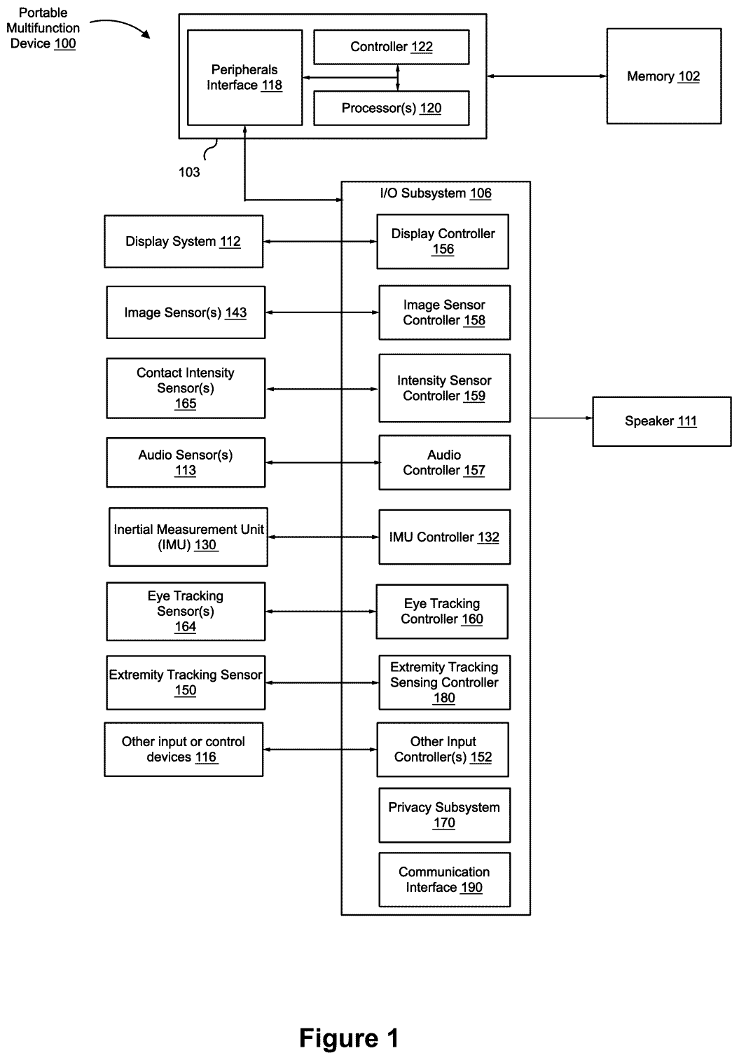

FIG. 1 is a block diagram of an example of a portable multifunction device 100 (sometimes also referred to herein as the “electronic device 100” for the sake of brevity) in accordance with some implementations. The electronic device 100 includes memory 102 (which optionally includes one or more computer readable storage mediums), a memory controller 122, one or more processing units (CPUs) 120, a peripherals interface 118, an input/output (I/O) subsystem 106, a speaker 111, a display system 112, an inertial measurement unit (IMU) 130, image sensor(s) 143 (e.g., camera), contact intensity sensor(s) 165, audio sensor(s) 113 (e.g., microphone), eye tracking sensor(s) 164 (e.g., included within a head-mountable device (HMD)), an extremity tracking sensor 150, and other input or control device(s) 116. In some implementations, the electronic device 100 corresponds to one of a mobile phone, tablet, laptop, wearable computing device, head-mountable device (HMD), head-mountable enclosure (e.g., the electronic device 100 slides into or otherwise attaches to a head-mountable enclosure), or the like. In some implementations, the head-mountable enclosure is shaped to form a receptacle for receiving the electronic device 100 with a display.

In some implementations, the peripherals interface 118, the one or more processing units 120, and the memory controller 122 are, optionally, implemented on a single chip, such as a chip 103. In some other implementations, they are, optionally, implemented on separate chips.

The I/O subsystem 106 couples input/output peripherals on the electronic device 100, such as the display system 112 and the other input or control devices 116, with the peripherals interface 118. The I/O subsystem 106 optionally includes a display controller 156, an image sensor controller 158, an intensity sensor controller 159, an audio controller 157, an eye tracking controller 160, one or more input controllers 152 for other input or control devices, an IMU controller 132, an extremity tracking controller 180, a privacy subsystem 170, and a communication interface 190. The one or more input controllers 152 receive/send electrical signals from/to the other input or control devices 116. The other input or control devices 116 optionally include physical buttons (e.g., push buttons, rocker buttons, etc.), dials, slider switches, joysticks, click wheels, and so forth. In some alternate implementations, the one or more input controllers 152 are, optionally, coupled with any (or none) of the following: a keyboard, infrared port, Universal Serial Bus (USB) port, stylus, auxiliary device, and/or a pointer device such as a mouse. The one or more buttons optionally include an up/down button for volume control of the speaker 111 and/or audio sensor(s) 113. The one or more buttons optionally include a push button. In some implementations, the other input or control devices 116 includes a positional system (e.g., GPS) that obtains information concerning the location and/or orientation of the electronic device 100 relative to a particular object. In some implementations, the other input or control devices 116 include a depth sensor and/or a time of flight sensor that obtains depth information characterizing a particular object.

The display system 112 provides an input interface and an output interface between the electronic device 100 and a user. The display controller 156 receives and/or sends electrical signals from/to the display system 112. The display system 112 displays visual output to the user. The visual output optionally includes graphics, text, icons, video, and any combination thereof (collectively termed “graphics”). In some implementations, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

The display system 112 may have a touch-sensitive surface, sensor, or set of sensors that accepts input from the user based on haptic and/or tactile contact. The display system 112 and the display controller 156 (along with any associated systems and/or sets of instructions in the memory 102) detect contact (and any movement or breaking of the contact) on the display system 112 and converts the detected contact into interaction with user-interface objects (e.g., one or more soft keys, icons, web pages or images) that are displayed on the display system 112. In an example implementation, a point of contact between the display system 112 and the user corresponds to a finger of the user or an auxiliary device.

In some implementations, the display system 112 corresponds to a display integrated in a head-mountable device (HMD), such as AR glasses. For example, the display system 112 includes a stereo display (e.g., stereo pair display) that provides (e.g., mimics) stereoscopic vision for eyes of a user wearing the HMD.

The display system 112 optionally uses LCD (liquid crystal display) technology, LPD (light emitting polymer display) technology, or LED (light emitting diode) technology, although other display technologies are used in other implementations. The display system 112 and the display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the display system 112.

The user optionally makes contact with the display system 112 using any suitable object or appendage, such as an auxiliary device, an extremity (e.g., a finger), and so forth. In some implementations, the user interface is designed to work with finger-based contacts and gestures, which can be less precise than stylus-based input due to the larger area of contact of a finger on the touch screen. In some implementations, the electronic device 100 translates the rough finger-based input into a precise pointer/cursor position or command for performing the actions desired by the user.

The speaker 111 and the audio sensor(s) 113 provide an audio interface between a user and the electronic device 100. Audio circuitry receives audio data from the peripherals interface 118, converts the audio data to an electrical signal, and transmits the electrical signal to the speaker 111. The speaker 111 converts the electrical signal to human-audible sound waves. Audio circuitry also receives electrical signals converted by the audio sensors 113 (e.g., a microphone) from sound waves. Audio circuitry converts the electrical signal to audio data and transmits the audio data to the peripherals interface 118 for processing. Audio data is, optionally, retrieved from and/or transmitted to the memory 102 and/or RF circuitry by the peripherals interface 118. In some implementations, audio circuitry also includes a headset jack. The headset jack provides an interface between audio circuitry and removable audio input/output peripherals, such as output-only headphones or a headset with both output (e.g., a headphone for one or both ears) and input (e.g., a microphone).

The inertial measurement unit (IMU) 130 includes accelerometers, gyroscopes, and/or magnetometers in order measure various forces, angular rates, and/or magnetic field information with respect to the electronic device 100. Accordingly, according to various implementations, the IMU 130 detects one or more positional change inputs of the electronic device 100, such as the electronic device 100 being shaken, rotated, moved in a particular direction, and/or the like.

The image sensor(s) 143 capture still images and/or video. In some implementations, an image sensor 143 is located on the back of the electronic device 100, opposite a touch screen on the front of the electronic device 100, so that the touch screen is enabled for use as a viewfinder for still and/or video image acquisition. In some implementations, another image sensor 143 is located on the front of the electronic device 100 so that the user's image is obtained (e.g., for selfies, for videoconferencing while the user views the other video conference participants on the touch screen, etc.). In some implementations, the image sensor(s) are integrated within an HMD.

The contact intensity sensors 165 detect intensity of contacts on the electronic device 100 (e.g., a touch input on a touch-sensitive surface of the electronic device 100). The contact intensity sensors 165 are coupled with the intensity sensor controller 159 in the I/O subsystem 106. The contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). The contact intensity sensor(s) 165 receive contact intensity information (e.g., pressure information or a proxy for pressure information) from the physical environment. In some implementations, at least one contact intensity sensor 165 is collocated with, or proximate to, a touch-sensitive surface of the electronic device 100. In some implementations, at least one contact intensity sensor 165 is located on the side of the electronic device 100.

The eye tracking sensor(s) 164 detect eye gaze of a user of the electronic device 100 and generate eye tracking data indicative of the eye gaze of the user. In various implementations, the eye tracking data includes data indicative of a fixation point (e.g., point of regard) of the user on a display panel, such as a display panel within a head-mountable device (HMD), a head-mountable enclosure, or within a heads-up display.

The extremity tracking sensor 150 obtains extremity tracking data indicative of a position of an extremity of a user. For example, in some implementations, the extremity tracking sensor 150 corresponds to a hand tracking sensor that obtains hand tracking data indicative of a position of a hand or a finger of a user within a particular object. In some implementations, the extremity tracking sensor 150 utilizes computer vision techniques to estimate the pose of the extremity based on camera images.

In various implementations, the electronic device 100 includes a privacy subsystem 170 that includes one or more privacy setting filters associated with user information, such as user information included in extremity tracking data, eye gaze data, and/or body position data associated with a user. In some implementations, the privacy subsystem 170 selectively prevents and/or limits the electronic device 100 or portions thereof from obtaining and/or transmitting the user information. To this end, the privacy subsystem 170 receives user preferences and/or selections from the user in response to prompting the user for the same. In some implementations, the privacy subsystem 170 prevents the electronic device 100 from obtaining and/or transmitting the user information unless and until the privacy subsystem 170 obtains informed consent from the user. In some implementations, the privacy subsystem 170 anonymizes (e.g., scrambles or obscures) certain types of user information. For example, the privacy subsystem 170 receives user inputs designating which types of user information the privacy subsystem 170 anonymizes. As another example, the privacy subsystem 170 anonymizes certain types of user information likely to include sensitive and/or identifying information, independent of user designation (e.g., automatically).

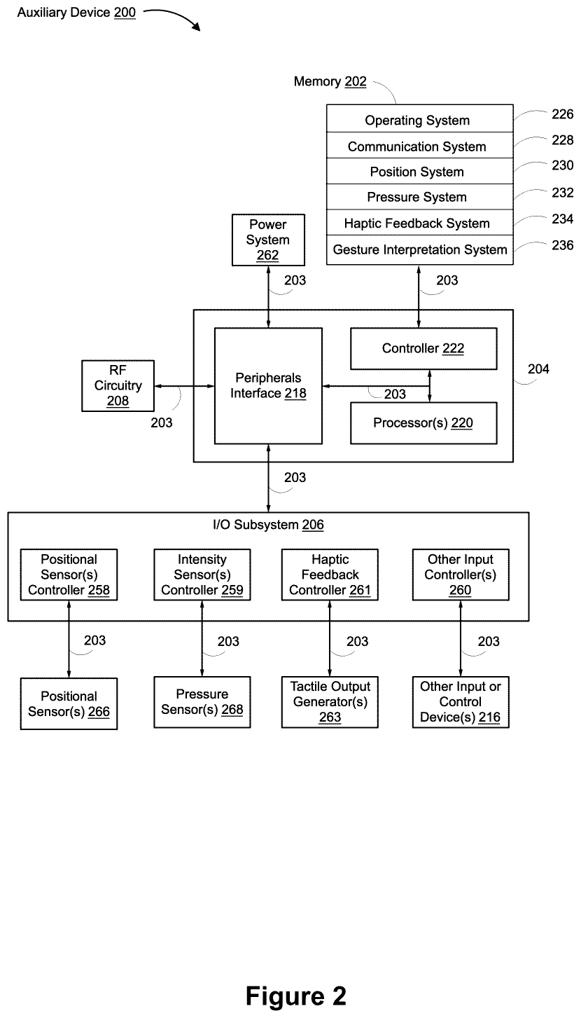

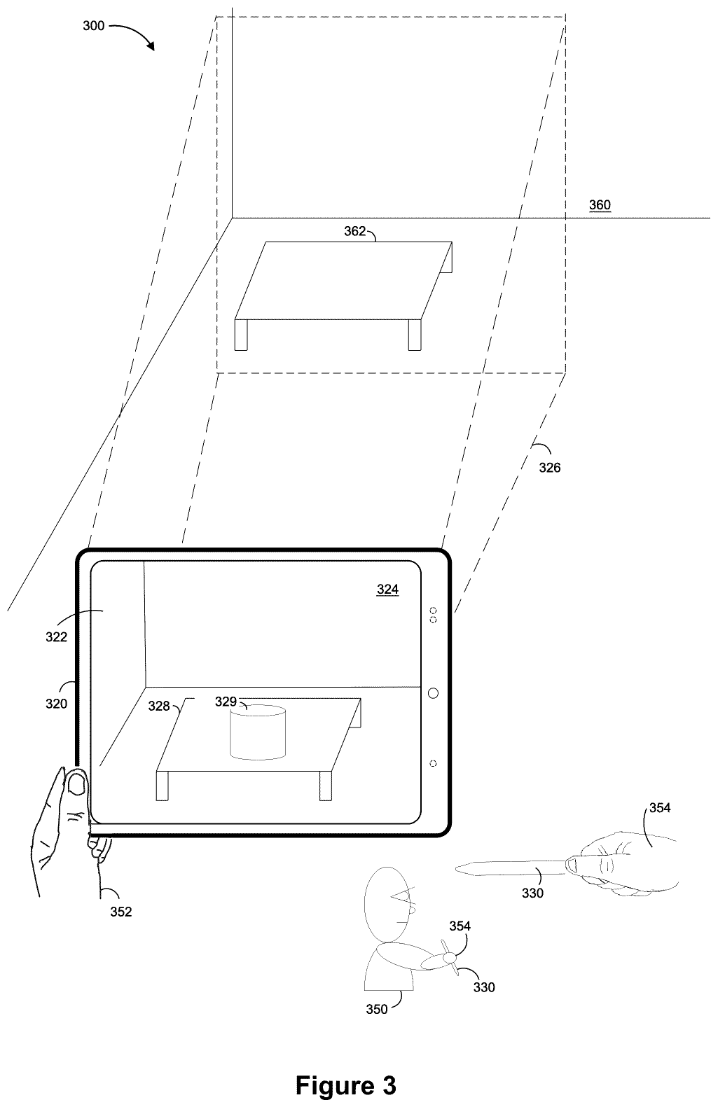

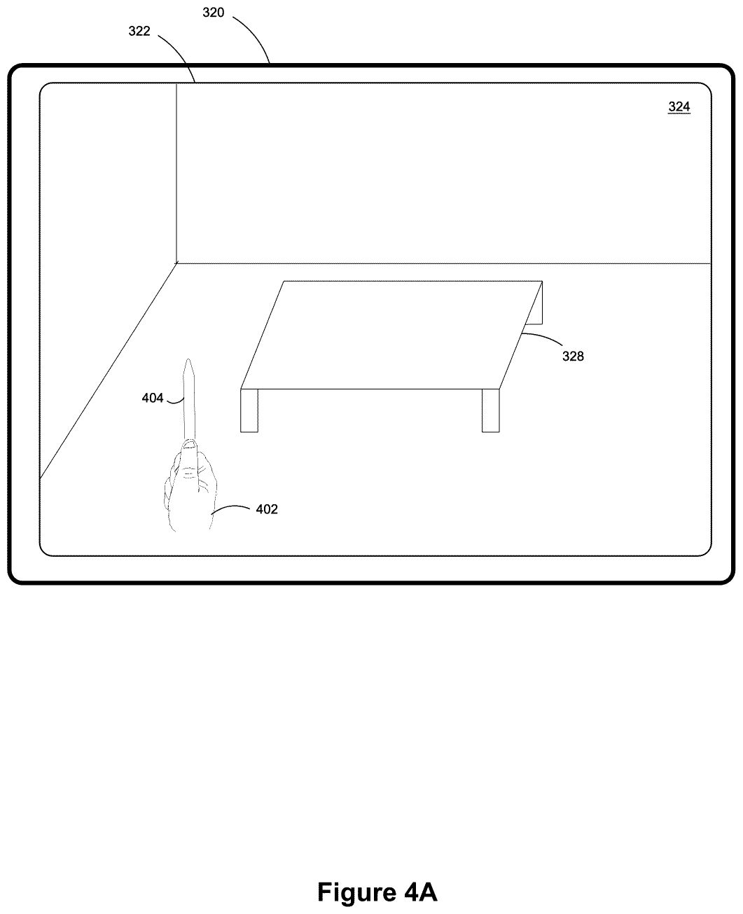

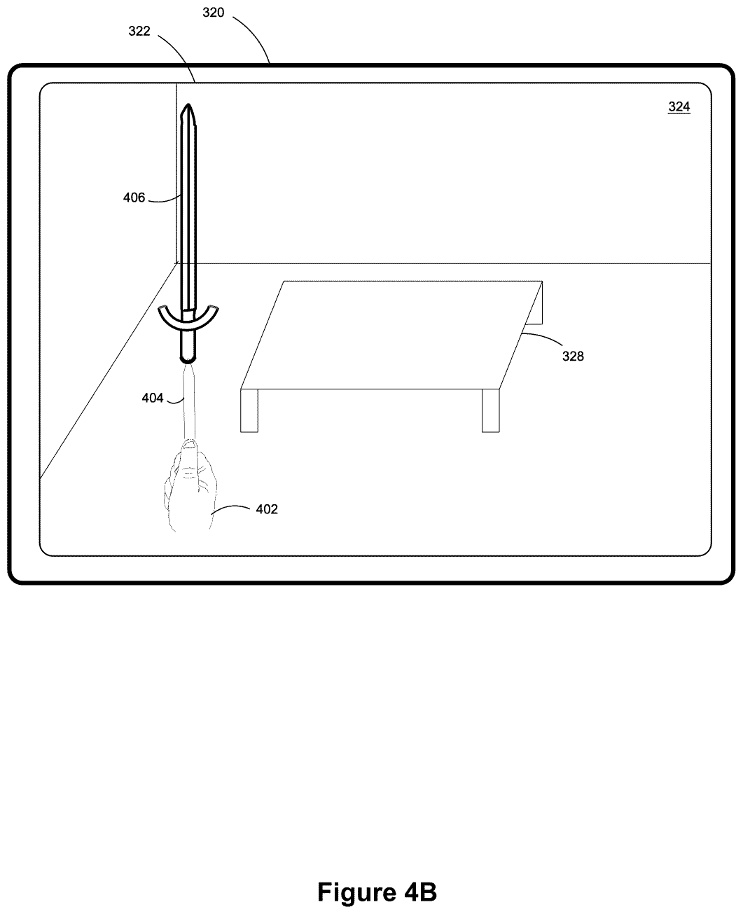

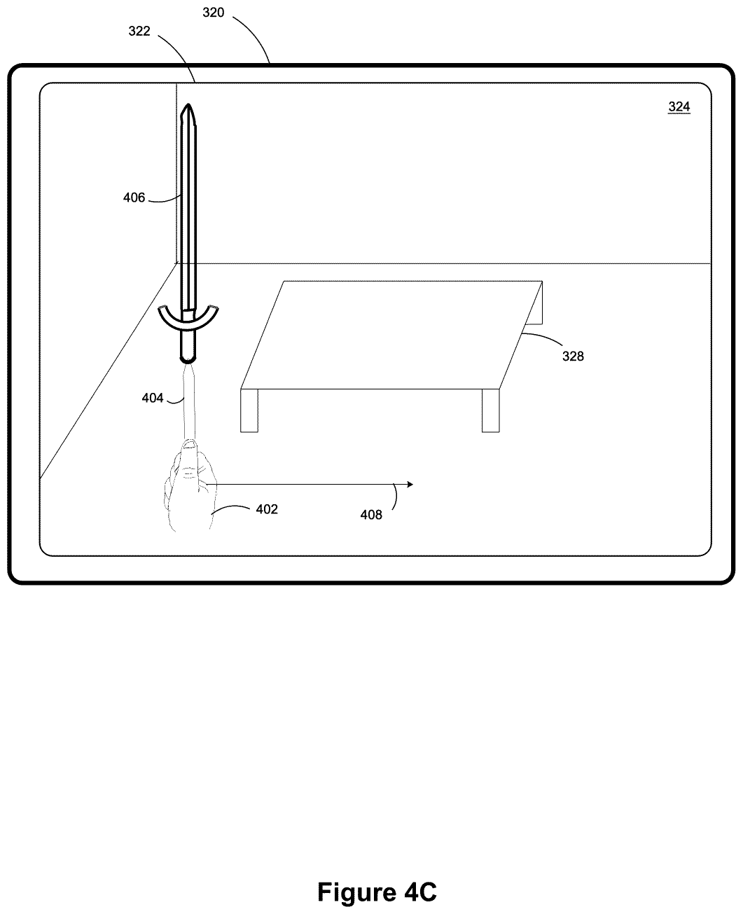

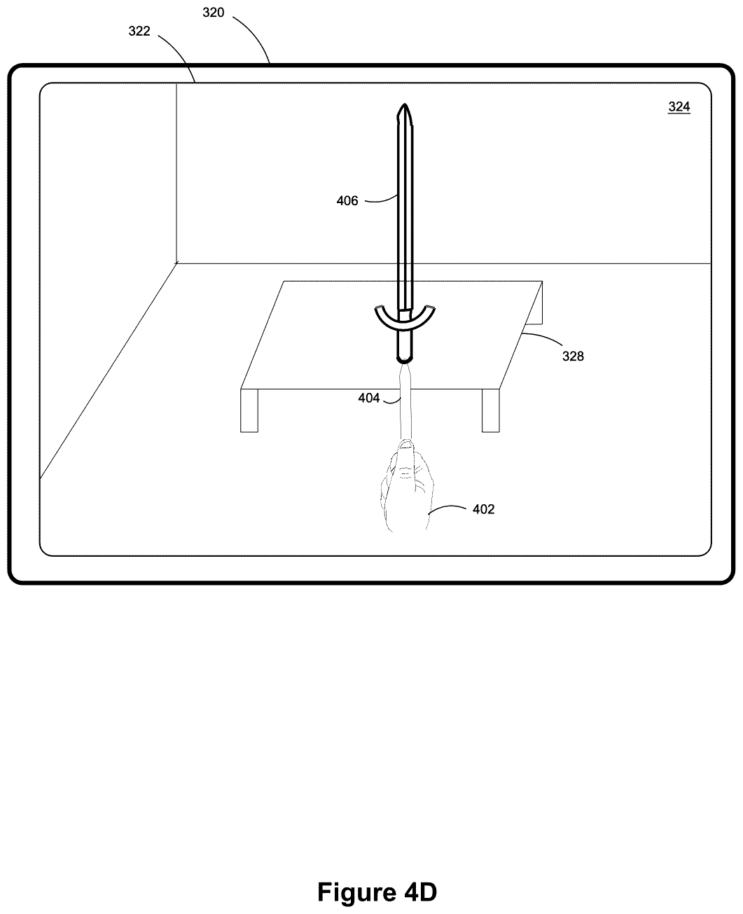

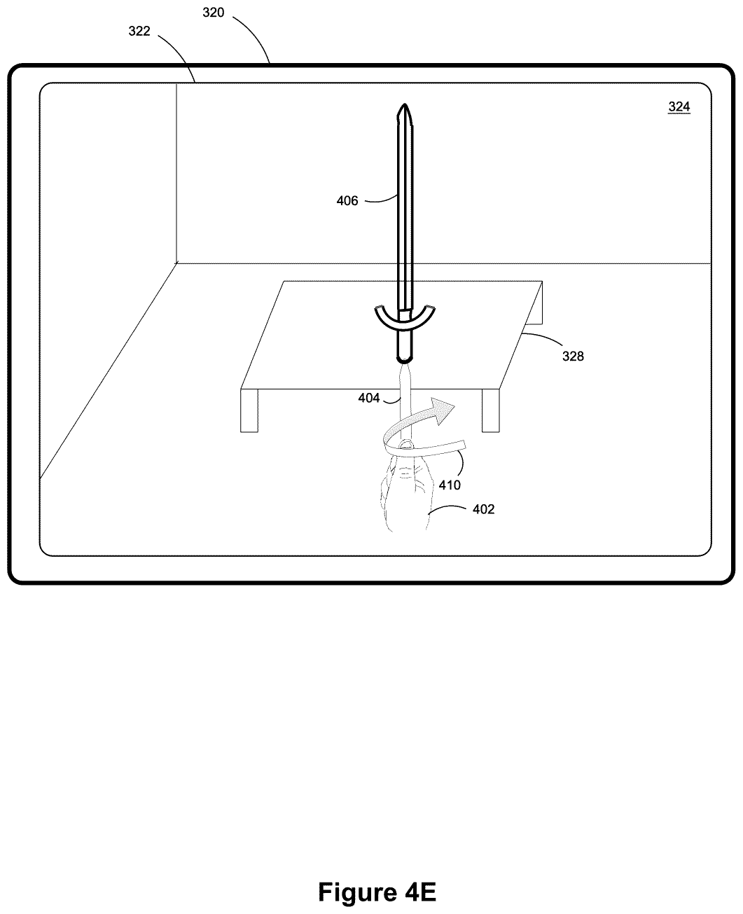

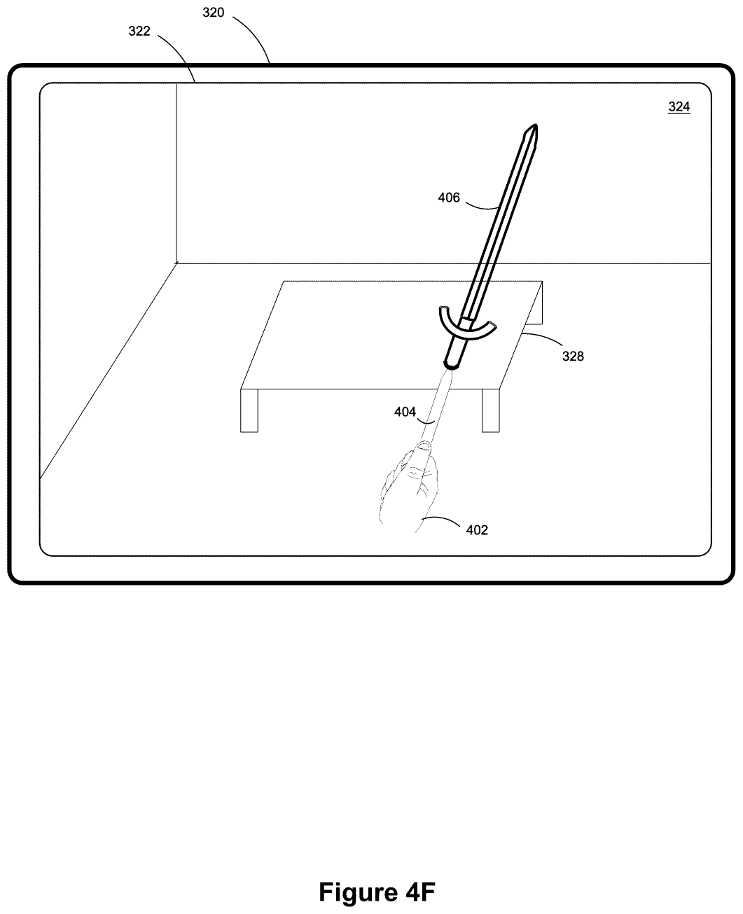

The electronic device 100 includes a communication interface 190 that is provided to communicate with an auxiliary device, such as the auxiliary device 200 illustrated in FIG. 2 or the second electronic device 330/404 illustrated in FIGS. 3 and 4A-4F. For example, the communication interface 190 corresponds to one of a BLUETOOTH interface, IEEE 802.11x interface, near field communication (NFC) interface, and/or the like. According to various implementations, the electronic device 100 obtains positional sensor data from the auxiliary device via the communication interface 190, as will be further described below.

FIG. 2 is a block diagram of an example of an auxiliary device 200, such as a handheld controller, a stylus, or a finger-wearable device. The auxiliary device 200 includes memory 202 (which optionally includes one or more computer readable storage mediums), memory controller 222, one or more processing units (CPUs) 220, peripherals interface 218, RF circuitry 208, and input/output (I/O) subsystem 206. These components optionally communicate over one or more communication buses or signal lines 203. One of ordinary skill in the art will appreciate that the auxiliary device 200 illustrated in FIG. 2 is one example of an auxiliary device, and that the auxiliary device 200 optionally has more or fewer components than shown, optionally combines two or more components, or optionally has a different configuration or arrangement of the components. The various components shown in FIG. 2 are implemented in hardware, software, firmware, or a combination thereof, including one or more signal processing and/or application specific integrated circuits.

The auxiliary device 200 includes a power system 262 for powering the various components. The power system 262 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices and/or portable accessories.

The memory 202 optionally includes high-speed random-access memory and optionally also includes non-volatile memory, such as one or more flash memory devices, or other non-volatile solid-state memory devices. Access to memory 202 by other components of the auxiliary device 200, such as CPU(s) 220 and the peripherals interface 218, is, optionally, controlled by memory controller 222.

The peripherals interface 218 can be used to couple input and output peripherals of the auxiliary device 200 to the CPU(s) 220 and the memory 202. The one or more processors 220 run or execute various software programs and/or sets of instructions stored in memory 202 to perform various functions for the auxiliary device 200 and to process data.

In some implementations, the peripherals interface 218, the CPU(s) 220, and the memory controller 222 are, optionally, implemented on a single chip, such as chip 204. In some implementations, they are implemented on separate chips.

The RF (radio frequency) circuitry 208 receives and sends RF signals, also called electromagnetic signals. The RF circuitry 208 converts electrical signals to/from electromagnetic signals and communicates with the electronic device 100, communications networks, and/or other communications devices via the electromagnetic signals. The RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity system (SIM) card, memory, and so forth. The RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), BLUETOOTH, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

The I/O subsystem 206 couples input/output peripherals on the auxiliary device 200, such as other input or control devices 216, with the peripherals interface 218. The I/O subsystem 206 optionally includes one or more positional sensor controllers 258, one or more intensity sensor controllers 259, a haptic feedback controller 261, and one or more other input controllers 260 for other input or control devices. The one or more other input controllers 260 receive/send electrical signals from/to other input or control devices 216. The other input or control devices 216 optionally include physical buttons (e.g., push buttons, rocker buttons, etc.), dials, slider switches, click wheels, and so forth. In some implementations, the other input controller(s) 260 are, optionally, coupled with any (or none) of the following: an infrared port and/or a USB port.

In some implementations, the auxiliary device 200 includes one or more positional sensors 266 that output positional sensor data associated with the auxiliary device 200. The positional sensor data is indicative of a position, orientation, or movement of the auxiliary device 200, such as a rotational movement or translational movement of the auxiliary device 200. For example, the positional sensor(s) 266 include an inertial measurement unit (IMU) that provides 3D rotational data, such as roll, pitch, and yaw information. To that end, the IMU may include a combination of an accelerometer, gyroscopes, and magnetometers. As another example, the positional sensor(s) 266 include a magnetic sensor that provides 3D positional data, such as the position of the auxiliary device 200. For example, the magnetic sensor measures weak magnetic fields in order to determine a position of the auxiliary device 200.

In some implementations, the auxiliary device 200 includes one or more pressure sensors 268 for detecting intensity (e.g., force or pressure) of a contact of a finger, wearing the auxiliary device 200, on a physical object. The one or more pressure sensors 268 output pressure sensor data associated with the auxiliary device 200. As one example, the pressure sensor data is indicative of the force or pressure of a tap gesture associated with a finger, which is wearing the auxiliary device 200, tapping on a surface of a physical table. The one or more pressure sensors 268 may include an interferometer. The one or more pressure sensors 268 may include one or more piezoresistive strain gauges, capacitive force sensors, electric force sensors, piezoelectric force sensors, optical force sensors, capacitive touch-sensitive surfaces, or other intensity sensors. Based on receiving data from the one or more pressure sensors 268, an electronic device may determine a gesture performed on the auxiliary device 200, such as a tap gesture, swipe gesture, etc.

The auxiliary device 200 optionally includes one or more tactile output generators 263 for generating tactile outputs on the auxiliary device 200. In some implementations, the term “tactile output” refers to physical displacement of an accessory (e.g., the auxiliary device 200) of an electronic device (e.g., the electronic device 100) relative to a previous position of the accessory, physical displacement of a component of an accessory relative to another component of the accessory, or displacement of the component relative to a center of mass of the accessory that will be detected by a user with the user's sense of touch. For example, in situations where the accessory or the component of the accessory is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the accessory or the component of the accessory. For example, movement of a component (e.g., the housing of the auxiliary device 200) is, optionally, interpreted by the user as a “click” of a physical actuator button. In some cases, a user will feel a tactile sensation such as a “click” even when there is no movement of a physical actuator button associated with the auxiliary device 200 that is physically pressed (e.g., displaced) by the user's movements. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., a “click,”), unless otherwise stated, the generated tactile output corresponds to physical displacement of the electronic device or a component thereof that will generate the described sensory perception for a typical (or average) user.

FIG. 2 shows the tactile output generator(s) 263 coupled with a haptic feedback controller 261. The tactile output generator(s) 263 optionally include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the electronic device). The tactile output generator(s) 263 receive tactile feedback generation instructions from a haptic feedback system 234 and generates tactile outputs on the auxiliary device 200 that are capable of being sensed by a user of the auxiliary device 200.

In some implementations, the software components stored in the memory 202 include an operating system 226, a communication system (or set of instructions) 228, a position system (or set of instructions) 230, a pressure system (or set of instructions) 232, a haptic feedback system (or set of instructions) 234, and a gesture interpretation system (or set of instructions) 236. Furthermore, in some implementations, the memory 202 stores device/global internal state associated with the auxiliary device 200. The device/global internal state includes one or more of: sensor state, including information obtained from various sensors and other input or control devices 216 of the auxiliary device 200; positional state, including information regarding the position (e.g., position, orientation, tilt, roll and/or distance) of the auxiliary device 200 relative to an electronic device (e.g., the electronic device 100); and location information concerning the absolute position of the auxiliary device 200.

The operating system 226 includes various software components and/or drivers for controlling and managing general system tasks (e.g., memory management, power management, etc.) and facilitates communication between various hardware and software components.

The communication system 228 facilitates communication with other devices (e.g., the electronic device 100 or the first electronic device 320), and also includes various software components (e.g., for handling data received by the RF circuitry 208) that are adapted for coupling directly to other devices or indirectly over a network (e.g., the Internet, wireless LAN, etc.).

The position system 230, in conjunction with positional sensor data from the one or more positional sensor(s) 266, optionally detects positional information concerning the auxiliary device 200. The position system 230 optionally includes software components for performing various operations related to detecting the position of the auxiliary device 200 and detecting changes to the position of the auxiliary device 200 in a particular frame of reference. In some implementations, the position system 230 detects the positional state of the auxiliary device 200 relative to the electronic device and detects changes to the positional state of the auxiliary device 200 relative to the electronic device. As noted above, in some implementations, the electronic device 100/320 determines the positional state of the auxiliary device 200 relative to the electronic device and changes to the positional state of the auxiliary device 200 using information from the position system 230.

The pressure system 232, in conjunction with pressure sensor data from the one or more pressure sensor(s) 268, optionally detects contact intensity information associated with the auxiliary device 200. The pressure system 232 includes software components for performing various operations related to detection of contact, such as detecting the intensity and/or duration of a contact between the auxiliary device 200 and a desk surface. Determining movement of the point of contact, which is represented by a series of pressure data, optionally includes determining speed (magnitude), velocity (magnitude and direction), and/or an acceleration (a change in magnitude and/or direction) of the point of contact.

The haptic feedback system 234 includes various software components for generating instructions used by the tactile output generator(s) 263 to produce tactile outputs at one or more locations on auxiliary device 200 in response to user interactions with the auxiliary device 200.

The auxiliary device 200 optionally includes a gesture interpretation system 236. The gesture interpretation system 236 coordinates with the position system 230 and/or the pressure system 232 in order to determine a gesture performed by the auxiliary device 200. For example, the gesture includes one or more of: a pinch gesture, a pull gesture, a pinch and pull gesture, a rotational gesture, a tap gesture, and/or the like. In some implementations, the auxiliary device 200 does not include a gesture interpretation system, and an electronic device or a system determines a gesture performed by the auxiliary device 200 based on sensor data from the auxiliary device 200. In some implementations, a portion of the gesture determination is performed at the auxiliary device 200, and a portion of the gesture determination is performed at an electronic device/system. In some implementations, the gesture interpretation system 236 determines a time duration associated with a gesture. In some implementations, the gesture interpretation system 236 determines a pressure associated with a gesture, such as an amount of pressure associated with a finger (wearing the auxiliary device 200) tapping on a physical surface.

Each of the above identified systems and applications correspond to a set of executable instructions for performing one or more functions described above and the methods described in this application (e.g., the computer-implemented methods and other information processing methods described herein). These systems (e.g., sets of instructions) need not be implemented as separate software programs, procedures or systems, and thus various subsets of these systems are, optionally, combined or otherwise re-arranged in various embodiments. In some implementations, the memory 202 optionally stores a subset of the systems and data structures identified above. Furthermore, the memory 202 optionally stores additional systems and data structures not described above.

FIG. 3 is an example of an operating environment 300 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 300 includes an first electronic device 320 (e.g., a tablet, mobile phone, laptop, wearable computing device, or the like). The first electronic device 320 may correspond to the electronic device 100 described with reference to FIG. 1, or may include components of the electronic device 100.

In some implementations, the first electronic device 320 corresponds to a head-mountable device (HMD) that includes an integrated display (e.g., a built-in display) that displays a representation of the operating environment 300. In some implementations, the first electronic device 320 includes a head-mountable enclosure. In various implementations, the head-mountable enclosure includes an attachment region to which another device with a display can be attached. In various implementations, the head-mountable enclosure is shaped to form a receptacle for receiving another device that includes a display (e.g., the first electronic device 320). For example, in some implementations, the first electronic device 320 slides/snaps into or otherwise attaches to the head-mountable enclosure. In some implementations, the display of the device attached to the head-mountable enclosure presents (e.g., displays) the representation of the operating environment 300. For example, in some implementations, the first electronic device 320 corresponds to a mobile phone that can be attached to the head-mountable enclosure.

In some implementations, the first electronic device 320 is configured to manage and coordinate an XR experience (sometimes also referred to herein as a “XR environment” or a “virtual environment” or a “graphical environment”) for a user 350 with a left hand 352 and a right hand 354. In some implementations, the first electronic device 320 includes a suitable combination of software, firmware, and/or hardware. In some implementations, the first electronic device 320 is similar to and adapted from the electronic device 100 described with reference to FIG. 1. In some implementations, the first electronic device 320 is a computing device that is local or remote relative to a physical environment 360 that includes a physical table 362.

As illustrated in FIG. 3, the right hand 354 holds a second electronic device 330. In some implementations, the second electronic device 330 corresponds to the second auxiliary device 200 described with reference to FIG. 2, or includes some of the components of the second auxiliary device 200. Examples of the second electronic device 330 include a stylus, a finger-wearable device, a handheld controller, etc. In some implementations, the second electronic device 330 includes a touch-sensitive surface, which enables detection of a touch input from the user 350. For example, the touch-sensitive surface includes one or more pressure sensors (e.g., the pressure sensor(s) 268), which generate pressure sensor data. Continuing with this example, while the first electronic device 320 is communicatively coupled (e.g., paired) with the second electronic device 330, the first electronic device 320 receives the pressure sensor data from the second electronic device 330. The first electronic device 320 may determine a grip style or gesture performed on the second electronic device 330 based on the pressure sensor data.

In some implementations, the first electronic device 320 is configured to present computer-generated content. In some implementations, the first electronic device 320 is configured to present, on a display 322, a user interface (UI) and/or an XR environment 324 to the user 350. As illustrated in FIG. 3, the display 322 is associated with a viewable region 326 that includes the physical table 362. Accordingly, the displayed XR environment 324 includes a representation 328 of the physical table 362. For example, the first electronic device 320 includes an image sensor (e.g., camera) with a field-of-view (FOV) that approximates the viewable region 326. Continuing with this example, the image sensor captures image data of the physical environment 360 including the physical table 362, and the first electronic device 320 composites the image data with computer-generated content. As illustrated in FIG. 3, the computer-generated content includes a computer-generated cylinder 329, which may be world-locked (e.g., anchored) to the representation 328 of the physical table 362. As another example, the display 322 corresponds to a see-through display 322 (e.g., a transparent lens) that enables ambient light from the physical environment 360 to enter the display 322 for display. In this example, the ambient light includes light reflected off of the physical table 362 towards the see-through display 322.

According to various implementations, the first electronic device 320 includes a spatial selector tracker that tracks a spatial selector associated with the user 350.

For example, in some implementations, the spatial selector tracker tracks the second electronic device 330 based at least in part on positional sensor data from the second electronic device 330. For example, the sensor data indicates positional information regarding the second electronic device 330. Examples of the positional information include 3D rotational information regarding the second electronic device 330 (sometimes referred to as roll, pitch, and yaw), and/or 3D translational information regarding the second electronic device 330 (sometimes referred to as surge, heave, and sway). To that end, in some implementations, the spatial selector tracker includes a communication interface to enable communication with the second electronic device 330. The positional sensor data may be generated by an IMU of the second electronic device 330, or a magnetic sensor of the second electronic device 330. Based on the positional sensor data, the spatial selector tracker may perform three degrees of freedom (3 DOF) or six degrees of freedom (6 DOF) tracking of the second electronic device 330. In some implementations in which second electronic device 330 is within the viewable region 326, the spatial selector tracker tracks the second electronic device 330 based on a computer vision technique, optionally in combination with the positional sensor data from the second electronic device 330. To that end, in some implementations, the first electronic device 320 includes an image sensor that captures image data (e.g., one or more images) including the second electronic device 330. Moreover, the spatial selector tracker identifies a subset of pixels of the image data that correspond to the second electronic device 330. Examples of the computer vision technique include instance segmentation and semantic segmentation.

As another example, in some implementations, in addition to or instead of tracking the second electronic device 330, the spatial selector tracker tracks an extremity of the user 350, such as a finger of the right hand 354 or the entire right hand 354. For example, the spatial selector tracker tracks the extremity via a computer vision technique. To that end, in some implementations, the first electronic device 320 includes an image sensor that captures image data (e.g., one or more images) including the extremity, and the spatial selector tracker identifies a subset of pixels of the image data that correspond to the extremity. Examples of the computer vision technique include instance segmentation and semantic segmentation.

FIGS. 4A-4F are various examples of anchoring a computer-generated object to an electronic device based on movements of the electronic device in accordance with some implementations. The examples described with reference to FIGS. 4A-4F include the first electronic device 320 operating according to the operating environment 300. One of ordinary skill in the art will appreciate that other implementations include the first electronic device 320 operate according to other operating environments.

As illustrated in FIG. 4A, the first electronic device 320 displays, on the display 322, the representation 328 of the physical table 362. Moreover, because the right hand 354 and the second electronic device 330 are within a viewable region associated with the first electronic device 320, the display 322 presents a representation 402 of the right hand 354 and a representation 404 of the second electronic device 330. For example, the right hand 354 and the second electronic device 330 are within a FOV associated with an image sensor of the first electronic device 320. For the sake of brevity regarding the description of FIGS. 4B-4F, the representation 402 of the right hand 354 is referred to as “the right hand 402,” and the representation 404 of the second electronic device 330 is referred to as “the second electronic device 404.”

According to various implementations, the first electronic device 320 presents, on the display 322, one or more computer-generated objects within the operating environment 300, which may include two-dimensional (2D) object(s) or three-dimensional (3D) object(s).

In some implementations, a computer-generated object is world-locked (e.g., anchored) to a point or portion of a physical environment, such as locked to a point of the representation 328 of the physical table 362. To support world-locking, based on detecting a movement of the first electronic device 320, the first electronic device 320 repositions the computer-generated object on the display 322 so as to maintain the position of the computer-generated object within the operating environment 300. For example, based on detecting a rightwards rotation of the first electronic device 320, the first electronic device 320 correspondingly moves a computer-generated object leftwards on the display 322.

In some implementations, a computer-generated object is dynamically locked (e.g., anchored) to a physical object used to control (e.g., manipulate) the computer-generated object. For example, based on a movement of the physical object, the first electronic device 320 repositions a computer-generated object on the display 322 so as to maintain the locking of the computer-generated object to the physical object. In some implementations, the physical object corresponds to an extremity of a user, such as the right hand 402. In some implementations, the physical object corresponds to an electronic device including a positional sensor, such as the second electronic device 404. Examples of the sensor data include IMU data, magnetic sensor data, contact intensity sensor data, etc. In some implementations, the sensor data indicates positional information or movement information regarding the second electronic device 404. In some implementations, the movement information includes a combination of translational movement information and rotational movement information. For example, in some implementations, the first electronic device 320 determines translational movement information and rotational movement information based on positional information from the second electronic device 404.

In some implementations, the first electronic device 320 locks a computer-generated object to the physical object based on computer vision tracking of the physical object. For example, the first electronic device 320 includes an image sensor that captures the physical object within image data, and the first electronic device 320 performs per pixel object identification (e.g., instance segmentation or semantic segmentation) of the physical object within the image data.

In some implementations, the first electronic device 320 locks a computer-generated object to the physical object based on a combination of computer vision tracking of the physical object and sensor data from the physical object.

For example, as illustrated in FIG. 4B, the first electronic device 320 renders at a first time, and displays a computer-generated sword 406 on the display 322. The computer-generated sword 406 is to be anchored to an anchor point of the second electronic device 404. The anchor point is the tip of the second electronic device 404, but one of ordinary skill in the art will appreciate that the anchor point may correspond to any location of the second electronic device 404. As will be described below, to maintain the anchoring the first electronic device 320 subsequently warps the computer-generated sword 406 based on a corresponding movement of the second electronic device 404.

Based on movements of the second electronic device 404, previously available techniques would visually distort the computer-generated sword 406 when attempting to anchor the computer-generated sword 406 to the second electronic device 404. For example, a delay exists between receiving movement information regarding the movement of the second electronic device 404 and updating the display of the computer-generated sword 406. Accordingly, previous techniques introduce visual distortion when updating display of the computer-generated sword 406 as anchored to the anchor point of the second electronic device 404.

To address these issues, various implementations disclosed herein include warping one or more portions of (or all of) the computer-generated sword 406 based on a predicted pose of the second electronic device 404 at a second time. The second time is later than the first time at which the computer-generated sword 406 was rendered. To that end, warping portions of the computer-generated sword 406 may be based on respective distances between each of the portions of the computer-generated sword 406 and the predicted pose of the second electronic device 404. Moreover, according to various implementations, warping portions of the computer-generated sword 406 is based on a movement type (e.g., translational versus rotational) associated with the predicted pose.

For example, as illustrated in FIG. 4C, the second electronic device 404 begins a translational movement rightwards across the XR environment 324, towards the right edge of the representation 328 of the physical table 362. The translational movement is indicated by a first movement indicator 408, which is illustrated for purely explanatory purposes. For example, the translational movement is characterized by each point of the right hand 402 moving away from the left edge of the display 322 at a substantially similar rate. As illustrated in FIG. 4D, the second electronic device 404 finishes the translational movement rightwards across the XR environment 324.

During the translational movement, the first electronic device 320 tracks positional changes of the second electronic device 404, such as based on IMU data from the second electronic device 404 and/or by applying computer vision to the second electronic device 404. In some implementations, based on the tracking, the first electronic device 320 obtains a first predicted pose of the second electronic device 404 at the second time. The second time may occur between the current pose of the second electronic device 404 illustrated in FIG. 4C and the termination pose of the second electronic device 404 illustrated in FIG. 4D. For example, the first predicted pose corresponds to a midpoint between the current pose and the termination pose. The second time may correspond to the display time of the computer-generated object illustrated in FIG. 4D. In some implementations, the first electronic device 320 obtains a plurality of distinct predicted poses, each of which being associated with a different time of a movement of the second electronic device 404.

In order to maintain the anchoring of the computer-generated sword 406 to the second electronic device 404 during the translational movement with reduced distortion, the first electronic device 320 warps the computer-generated sword 406 based at least in part on the first predicted pose, and subsequently displays the warped the computer-generated sword 406 at a second time. Because the warping occurs later in the graphics pipeline than the rendering stage (e.g., between the rendering stage and the display stage), the warping may be characterized as a late stage warping. Warping the computer-generated sword 406 based at least in part on the first predicted pose reduces visual distortion of the computer-generated sword 406 during the translational movement, as compared with other techniques.

To that end, in some implementations, the first electronic device 320 warps different portions of the computer-generated sword 406 based on respective distances between each of the portions and the first predicted pose. For example, the tip of the computer-generated sword 406 is farther from the second electronic device 404 than the base of the computer-generated sword 406 is from the second electronic device 404. Accordingly, based on this difference, in some implementations the first electronic device 320 warps the tip according to a respective warping parameter that is nominally dependent on the first predicted pose, and warps the base according to a respective warping parameter that is more dependent on the first predicted pose. In some implementations, the respective warping parameter associated with the tip is more dependent on a pose of the first electronic device 320 than the first predicted pose. For example, the respective warping parameter associated with the tip is based on a head position of a user when the first electronic device 320 is a HMD worn by the user. In some implementations, distances between portions of a computer-generated object and a predicted pose correspond to spherical distances in 3D space. In some implementations, warping the computer-generated sword 406 includes performing linear interpolation (lerp) on portions of the computer-generated sword 406, based on the respective distances between each of the portions and the first predicted pose.

As another example, as illustrated in FIG. 4E, at a third time after termination of the translational movement, the second electronic device 404 begins a rotational movement. The rotational movement is indicated by a second movement indicator 410, which is illustrated for purely explanatory purposes. In contrast to the translational movement, the rotational movement is characterized by certain points of the right hand 402 moving away from the left edge of the display 322 at faster rates than other points of the right hand 402. As illustrated in FIG. 4F, the second electronic device 404 finishes the rotational movement.

During the rotational movement, the first electronic device 320 tracks positional changes of the second electronic device 404, such as based on IMU data from the second electronic device 404 or by applying computer vision to the second electronic device 404. In some implementations, based on the tracking, the first electronic device 320 obtains a second predicted pose of the second electronic device 404 at a fourth time, which may occur at or before the termination of the rotational movement. For example, the fourth time occurs between the current pose of the second electronic device 404 illustrated in FIG. 4E and the termination pose of the rotational movement of the second electronic device 404 illustrated in FIG. 4F.

In some implementations, to account for the rotational nature of the rotational movement, the first electronic device 320 warps portions of the computer-generated sword 406 based on respective distances between each of the portions and the center of the second predicted pose. For example, the first electronic device 320 applies a spherical drop off based on respective distances between each of the portions and the center of the second predicted pose. Accordingly, warping based on a rotational movement may be parametrized about the center of the second electronic device 404. Subsequently, the first electronic device 320 displays the warped portion(s) of the computer-generated sword 406 at the fourth time.

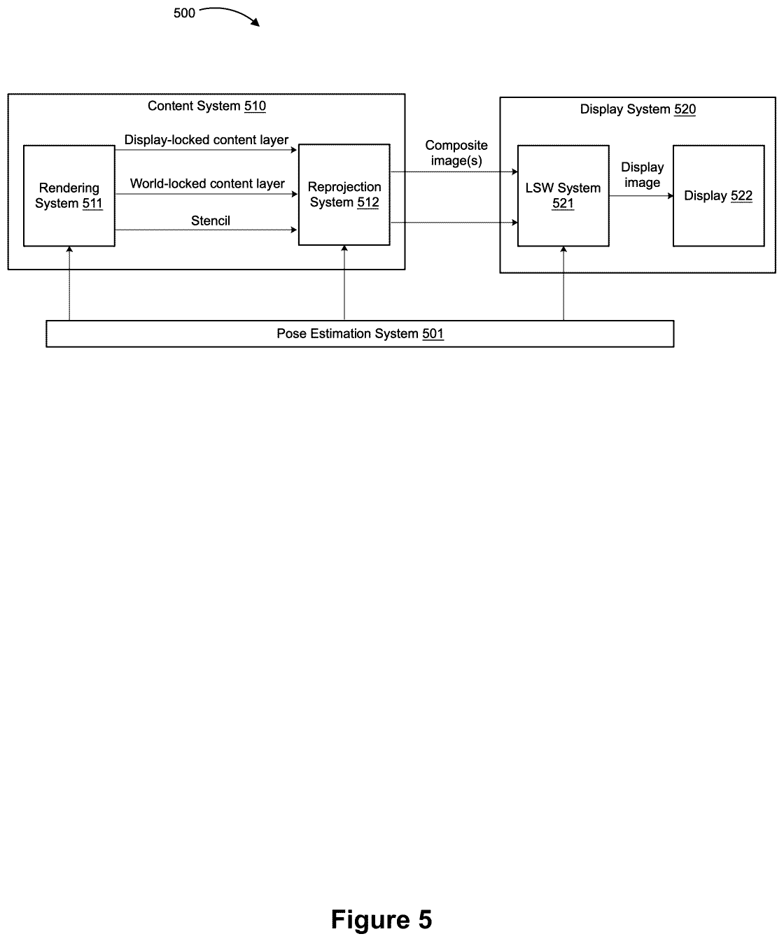

FIG. 5 is an example of a first electronic device 500 in accordance with some implementations. In some implementations, the first electronic device 500 is similar to and adapted from the first electronic device 320 described with reference to FIGS. 3 and 4A-4F.

The first electronic device 500 includes a pose estimation system 501 that determines a current pose of a physical object and/or predicted pose(s) of the physical object. For example, the physical object corresponds to the second electronic device 330/404 described with reference to FIGS. 3 and 4A-4F. In various implementations, the pose estimation system 501 determines a current pose based on camera-based pose tracking and/or IMU (inertial measurement unit) tracking. In various implementations, the pose estimation system 501 determines the predicted pose of by extrapolating previous motions of the physical object, and optionally based on previous motions of the first electronic device 500. For example, the pose estimation system 501 determines the predicted pose based on relative motions of the physical object and the first electronic device 500.

In some implementations, the physical object corresponds to an extremity of a user of the first electronic device 320. To that end, in some implementations, the first electronic device 320 includes a camera that captures image data of a physical environment, and the first electronic device 320 performs object identification (e.g., computer vision) of the image data to identify an extremity of the user. In various implementations, the pose estimation system 501 determines the current pose of an extremity of the user based on IMU data received from a watch worn by the user. As another example, in various implementations, the pose estimation system 501 determines the current pose of the extremity of the user based on IMU data received from a stylus held by the extremity of the user.

In some implementations, the pose estimation system 501 obtains sensor data regarding a physical object, and combines (e.g., fuses) the sensor data with previous sensor data. For example, sensor data includes camera-captured image data representing the physical object and/or data generated by an IMU integrated in the physical object. Based on the combination of the sensor data and the previous sensor data, the pose estimation system 501 may periodically or semi-periodically determine a current pose of a physical object and/or predicted pose(s) of the physical object. In some implementations, based on a query (e.g., from a client or process) for an updated pose prediction of the physical object, the pose estimation system 501 assesses the most recently obtained sensor data in order to determine the updated pose prediction.

In some implementations, the pose estimation system 501 coordinates with another component of the first electronic device 500, in order to determines a current pose of a physical object and/or predicted pose(s) of the physical object. To that end, in some implementations, the pose estimation system 501 obtains positional information regarding a physical object, transmits the positional information to the other component, and the other component determines the current pose of a physical object and/or predicted pose(s) of the physical object based on the positional information. For example, in some implementations, the pose estimation system 501 transmits a sub-portion of (e.g., less than the entirety of) the positional information to the other component within a processing window. Continuing with this example, within the processing window, the other component uses the sub-portion of the positional information to determines a current pose of a physical object and/or predicted pose(s) of the physical object. Thus, the first electronic device 500 is able to determine the current pose and/or predicted pose(s) without needing to wait to obtain the entirety of the positional information, thereby reducing lower latency as compared with the pose estimation system 501 alone determining the current pose and/or predicted pose and transmitting the current pose and/or predicted pose to the other component. As one example, the other component is a reprojection system 512 or a late-stage warp (LSW) system 521. Accordingly, the lower latency associated with the reprojection system 512 or the LSW system 521 determining the current pose and/or predicted pose results in less display distortion associated with the corresponding reprojection and warping, both of which will be described below.

The first electronic device 500 includes a content system 510 that generates images at a display frame rate based on pose information from the pose estimation system 501, and further includes a display system 520 that displays, on a display 522, the images at the display frame rate.

The content system 510 includes a rendering system 511 that generates rendered images at a rendering frame rate based on pose information from the pose estimation system 501. In various implementations, the rendering frame rate is approximately equal to the display frame rate. In various implementations, the rendering frame rate is less than the display frame rate. For example, in various implementations, the rendering frame rate is half the display frame rate.

In various implementations, the rendered images each include a display-locked content layer including display-locked content that is rendered independent of the pose information from the pose estimation system 501 and one or more world-locked content layers including world-locked content that is rendered based on the pose information from the pose estimation system 501.

As an example, the rendering system 511 generates, at a first time period prior to a first display time period of a first display image, a first rendered image based on a first predicted pose of the first electronic device 500 during the first display time period and a first predicted pose of the physical object from the pose estimation system 501. The first rendered image includes a display-locked content layer, a static-anchored world-locked content layer, and one or more dynamic-anchored world-locked content layers. For example, with reference to FIG. 4B, the rendered image includes the computer-generated sword 406.

The content system 510 includes a reprojection system 512 that generates composite images at the display frame rate based on updated pose information from the pose estimation system 501. In various implementations, the reprojection system 512 generates the composite images by transforming the world-locked content layers of rendered images based on pose information from the pose estimation system 501 and flattening the rendered images into a single layer. In various implementations, the reprojection system 512 transforms each world-locked content layer by applying a homographic transformation to the world-locked content layer. In various implementations, the reprojection system 512 transforms each world-locked content layer using one or more other perspective transformations. For example, with reference to FIG. 4B, the composite image includes the computer-generated sword 406 anchored to the second electronic device 404.

As an example, the reprojection system 512 generates, at a second time period after the first time period and prior to the first display time period of the first display image, a first composite image based on a second predicted pose of the first electronic device 500 during the first display time period and a second predicted pose of the physical object. In various implementations, the reprojection system 512 generates the first composite image by transforming the static-anchored world-locked content layer of the first rendered image based on the second predicted pose of the first electronic device 500, and transforming the one or more dynamic-anchored world-locked content layers of the first rendered image based on the second predicted pose of the electronic device and the second predicted pose of the physical object. The second predicted pose and second predicted pose, being generated closer in time to the first display time period than the first predicted pose, are more accurate than the first predicted pose and the first predicted pose.

In some implementations, the reprojection system 512 further obtains, for each composite image, a stencil indicating how portions of the composite image are to be warped by the LSW system 521 described further below.

In various implementations, the stencil includes a matrix of the same resolution of the composite image, each element of the matrix corresponding to a pixel of the composite image. In various implementations, each element of the matrix has a value of ‘0’ if the corresponding pixel of the composite image is not to be warped by the LSW system 521, a value of ‘1’ if the corresponding pixel of the composite image is to be warped by the LSW system 521 based only on the pose of the first electronic device 500, a value of ‘2’ if the corresponding pixel of the composite image is to be warped by the LSW system 521 based on the pose of the first electronic device 500 and the pose of a physical object, a value of ‘3’ if the corresponding pixel of the composite image is to be warped by the LSW system 521 based on the pose of the first electronic device 500 and the pose of a first physical object and a pose of a second physical object, etc.

For example, pixels in the composite image corresponding to display-locked content have a value of ‘0’, pixels in the composite image corresponding to static-anchored world-locked content have a value of ‘1’, and pixels in the composite image corresponding to dynamic-anchored world-locked content (e.g., the computer-generated sword 406 anchored to the second electronic device 404) have a value of ‘2.’

The stencil may be defined in ways other than a matrix. For example, in various implementations, the stencil includes pixel coordinates indicating regions that are to be shifted by the LSW system 521, such as the corners of a rectangle surrounding a region to be shifted by the LSW system 521.

In some implementations, the LSW system 521 generates display images at the display frame rate based on updated pose information from the pose estimation system 501. In various implementations, the LSW system 521 performs a one-dimensional or two-dimensional pixel shift of portions of the composite images indicated by the corresponding stencil based on updated pose information from the pose estimation system 501.

As an example, the LSW system 521 generates, at a third time period after the second time period and prior to the first display time period of the first display image, the first display image based on a third predicted pose of the first electronic device 500 during the first display time period and a third predicted pose of the physical object. In various implementations, the LSW system 521 generates the first display image by shifting portions of the first composite image indicated by the stencil as corresponding to static-anchored world-locked content based on the third predicted pose of the first electronic device 500 and shifting portions of the first composite image indicated by the stencil as corresponding to dynamic-anchored world-locked content based on the third predicted pose of the first electronic device 500 and the third predicted pose of the physical object. The pose estimation system 501 generates the third predicted pose after generating the second predicted pose. The third predicted pose and the third predicted pose, being generated closer in time to the first display time period than the second predicted pose, are more accurate than the second predicted pose and the second predicted pose.

The display 522 displays the display images at the display frame rate. As an example, the display 522 displays the first display image at the first display time period.

As noted above, in various implementations, the display frame rate may be greater than the rendering frame rate. To achieve this, in various implementations, the reprojection system 512 performs frame rate extrapolation.

As an example, the reprojection system 512 generates, at a first time period prior to a second display time period of a second display image, a second composite image based on the first rendered image, a first predicted pose of the first electronic device 500 during the second display time period from the pose estimation system 501, and a first predicted pose of the physical object. In various implementations, the reprojection system 512 generates the second composite image by transforming the world-locked content layers of the first rendered image based on the first predicted pose of the electronic device and the first predicted pose, and compositing the transformed world-locked content layers and the display-locked content layer into a single layer. The LSW system 521 generates, at a second time period after the first time period and prior to the second display time period of the second display image, the second display image based on a second predicted pose of the first electronic device 500 during the second display time period and a second predicted pose of the physical object. In various implementations, the LSW system 521 generates the second display image by shifting portions of the second composite image indicated by the stencil as corresponding to static-anchored world-locked content based on the second predicted pose of the first electronic device 500, and shifting portions of the second composite image indicated by the stencil as corresponding to dynamic-anchored world-locked content based on the third predicted pose of the first electronic device 500 and the third predicted pose of the physical object. The display 522 displays the second display image at the second display time period.

In various implementations, the reprojection system 512 and the LSW system 521 operate concurrently. Thus, in some implementations, functionality described above with respect to the reprojection system 512 and the LSW system 521 is integrated into a single system, which performs the functionality during a single processing operation.

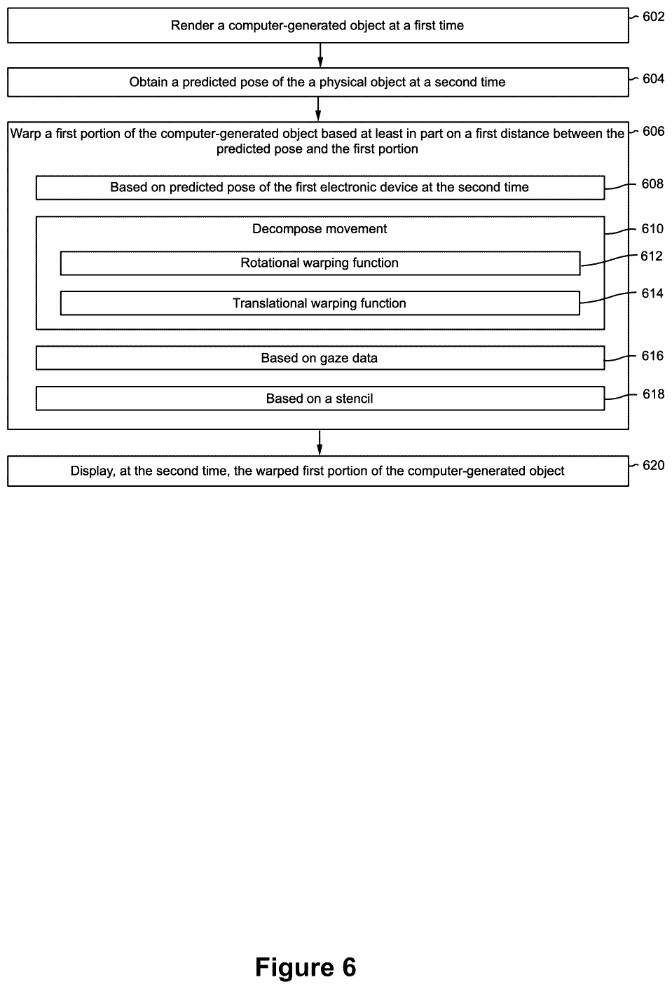

FIG. 6 is an example of a flow diagram of a method 600 of anchoring a computer-generated object to a physical object based on movements of the physical object in accordance with some implementations. In various implementations, the method 600 or portions thereof are performed by an electronic device including one or more processors, a non-transitory memory, and a display. For example, the first electronic device 320 described with reference to FIGS. 3 and 4A-4F performs the method 600. As another example, the first electronic device 500 described with reference to FIG. 5 performs the method 600.

In various implementations, the method 600 or portions thereof are performed by a head-mountable device (HMD). In some implementations, the method 600 is performed by processing logic, including hardware, firmware, software, or a combination thereof. In some implementations, the method 600 is performed by a processor executing code stored in a non-transitory computer-readable medium (e.g., a memory). In various implementations, some operations in method 600 are, optionally, combined and/or the order of some operations is, optionally, changed.

As represented by block 602, the method 600 includes rendering a computer-generated object at a first time. The computer-generated object is positionally dependent on a first physical object, such as the second electronic device 404 described with reference to FIGS. 3 and 4A-4F. As another example, the first physical object corresponds to an extremity of a user. For example, the method 600 includes anchoring the computer-generated object to the first physical object so that the computer-generated object is positionally dependent on a first physical object.

In some implementations, the computer-generated object is dynamically anchored to the first physical object. The first physical object may correspond to a device with sensor(s) (e.g., IMU, magnetic sensor), or may correspond to an extremity of a user. As one example, with reference to FIGS. 4B and 5, the rendering system 511 renders the computer-generated sword 406, and anchors the computer-generated sword 406 to the second electronic device 404. Maintaining the anchoring during movements of the second electronic device 404 includes using pose information from the pose estimation system 501, wherein the pose information relates to the first electronic device 500 and/or the second electronic device 404.

As represented by block 604, the method 600 includes obtaining a predicted pose of the first physical object at a second time. The second time is after the first time. For example, with reference to FIGS. 4C and 4D, the second time occurs during the translational movement of the second electronic device—e.g., before the termination of the translational movement. In various implementations, the method 600 includes tracking positions of the first physical object in order to determine the predicted pose of the first physical object at the second time.

In some implementations, the first physical object corresponds to a second electronic device that is communicatively coupled with the first electronic device. Moreover, the method 600 may include receiving sensor data from a sensor of the second electronic device, and determining the predicted pose based at least in part on the sensor data. The sensor data indicates one or more positions of the second electronic device. The sensor data may indicate a movement of the second electronic device.

In some implementations, the first physical object corresponds to an extremity of a user, and the method 600 includes tracking the extremity in order to determine the predicted pose of the extremity. For example, the tracking may include a variety of computer vision techniques, such as instance segmentation, semantic segmentation, etc.

In some implementations, the predicted pose corresponds to an estimation of a position of the first physical object when a user of a first electronic device (e.g., the first electronic device 320 or 500) is looking at the computer-generated object. To that end, in some implementations, the method 600 includes obtaining gaze data indicative one or more gaze points of the user.

In some implementations, the predicted pose indicates a predicted orientation of the first physical object at the second time. For example, an initial orientation of the second electronic device 404 at a first time in FIG. 4E is substantially upwards, whereas a predicted orientation of the second electronic device 404 at a second time is angled, with the tip of the second electronic device 404 being farther from the left edge of the display 322 than the base of the second electronic device 404 is from the left edge of the display 322.

In some implementations, the predicted pose indicates a predicted movement type of the first physical object at the second time. For example, based on IMU data from the first physical object, the method 600 includes predicts that the first physical object is to make a rotational movement.

In some implementations, the computer-generated object is concurrently positionally dependent on multiple physical objects. For example, while being anchored to the first physical object, the computer-generated object is anchored to a second physical object. For example, a user is concurrently holding two hand-held controllers, one in each hand. The method 600 may include obtaining a predicted pose of the second physical object at the second time, similar to the above described features relating to obtaining the predicted pose of the first physical object at the second time.

As represented by block 606, the method 600 includes warping a first portion of the computer-generated object based at least in part on a first distance between the predicted pose and the first portion. For example, the first portion corresponds to the base of the computer-generated sword illustrated in FIG. 4E, and pixels of the computer-generated sword corresponding to the base are warped based on respective distances between each of the pixels and the predicted pose. In some implementations, warping the first portion includes shifting the computer-generated object. In some implementations, the first physical object has a current pose at the first time different from the predicted pose, and the warping is based on a difference between the current pose and the predicted pose. In some implementations, warping the first portion is also based on the based on the predicted pose of the second physical object at the second time. To that end, in some implementations, the method 600 includes determining a second distance between the first portion and the predicted pose of the second physical object at the second time.

In some implementations, warping the first portion based on the first distance is in response to determining that the first distance is less than a threshold. For example, with reference to FIGS. 4C and 4D, the method 600 includes warping the base (the first portion) of the computer-generated sword 406 based on the predicted pose, because the base is sufficiently near the second electronic device 404. On the other hand, in some implementations, the method 600 includes foregoing warping the tip (a second portion) of the computer-generated sword 406 based on the predicted pose, because the tip is not sufficiently near the second electronic device 404.

As represented by block 608, in some implementations, the method 600 includes warping the first portion further based on a predicted pose of the first electronic device (e.g., pose of an HMD worn by a user) at the second time. Thus, in some implementations, warping the first portion is based on both the first distance and the predicted pose of the first electronic device.

In some implementations, the method 600 includes determining a second distance between the predicted pose and a second portion of the computer-generated object. In response to determining that the second distance is less than the threshold, warping the second portion may be based on the second distance and the predicted pose of the first electronic device. On the other hand, in response to determining that the second distance is not less than the threshold, warping the second portion may be based on the predicted pose of the first electronic device only (e.g., not based on the second distance).

As represented by block 610, in some implementations, warping the first portion is further based on a determined movement type of the first physical object. The movement type is associated with a movement of the first physical object occurring between the first and second times. For example, for a rotational movement type (e.g., as illustrated in FIGS. 4E and 4F), the method 600 includes applying the first distance to a rotational warping function, as represented by block 612. Performing the rotational warping function may include performing a spherical linear interpolation (slerp) based on the first distance. As another example, for a translational movement type (e.g., as illustrated in FIGS. 4C and 4D), the method 600 includes applying the first distance to a translational warping function, as represented by block 614. Performing the translational warping function may include performing a linear interpolation (lerp) based on the first distance. As yet another example, for a combination rotational and translational movement type, the method 600 includes applying the first distance to a translational warping function and to a rotational warping function. Accordingly, the method 600 enables decomposing reprojection into translational and rotational components, providing greater accuracy and warping control, which itself may reduce processor utilization.

In some implementations, when the movement type is determined to be rotational, warping is based on a distance between the first portion and the center of the first physical object, because the center of the first physical object is more significant for a rotational movement than a translational movement.

As represented by block 616, in some implementations, warping the first portion is further based on gaze data indicative of gaze point(s) of the user. For example, warping the first portion is based on determining that the gaze point is less than a threshold distance from the first portion. In other words, if the gaze point is directed to the computer-generated object, warping occurs, but if the gaze point is not directed to the computer-generated object, warping does not occur, thereby reducing processor utilization. In some implementations, if the gaze point is directed to the computer-generated object, and the computer-generated object overlaps with another computer-generated object (e.g., computer-generated sword is in front of a virtual bookshelf), the method 600 includes foregoing warping the other computer-generated object, further reducing processor utilization.

As represented by block 618, in some implementations, warping the first portion is based on a stencil. The stencil may indicate portions of the computer-generated object that are to be warped and portions of the computer-generated object that are not to be warped. For example, the stencil corresponds to a matrix of elements, and if an element of the matrix has a value of ‘0,’ the corresponding pixel of the computer-generated object is not to be warped, whereas a value of ‘1’ indicates the corresponding pixel is to be warped. The stencil is further described with reference to FIG. 5, above.

As represented by block 620, the method 600 includes displaying, on a display at the second time, the warped first portion of the computer-generated object. Display of the warped first portion enables the first portion to be anchored to the first physical object based on a movement of the first physical object. Using the predicted pose of the first physical object at the second time enables warping of the first portion before the display at the second time, thereby reducing visual distortion. In some implementations, at the second time, the method 600 includes concurrently displaying the warped first portion and the warped second portion.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or systems stored in a memory or other non-transitory computer-readable storage medium or device. The various functions disclosed herein may be implemented in such program instructions, although some or all of the disclosed functions may alternatively be implemented in application-specific circuitry (e.g., ASICs or FPGAs or GP-GPUs) of the computer system. Where the computer system includes multiple computing devices, these devices may be co-located or not co-located. The results of the disclosed methods and tasks may be persistently stored by transforming physical storage devices, such as solid-state memory chips and/or magnetic disks, into a different state.

Various processes defined herein consider the option of obtaining and utilizing a user's personal information. For example, such personal information may be utilized in order to provide an improved privacy screen on an electronic device. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various implementations described above can be combined to provide further implementations. Accordingly, the novel methods and systems described herein may be implemented in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
at a first electronic device including one or more processors, a non-transitory memory, and a display:
rendering a computer-generated object at a first time, wherein the computer-generated object is positionally dependent on a first physical object;
obtaining a predicted pose of the first physical object at a second time, wherein the second time is after the first time;
warping a first portion of the computer-generated object based at least in part on a first distance between the predicted pose and the first portion; and
displaying, on the display at the second time, the warped first portion of the computer-generated object.

2. The method of claim 1, wherein warping the first portion based on the first distance is in response to determining that the first distance is less than a threshold.

3. The method of claim 1, further comprising obtaining a predicted pose of the first electronic device at the second time, wherein warping the first portion is further based on the predicted pose of the first electronic device.

4. The method of claim 3, further comprising:
determining a second distance between the predicted pose and a second portion of the computer-generated object;
in response to determining that the second distance is less than a threshold, warping the second portion based on the second distance and the predicted pose of the first electronic device; and
while displaying the warped first portion at the second time, displaying the warped second portion at the second time.

5. The method of claim 3, further comprising:
determining a second distance between the predicted pose and a second portion of the computer-generated object;
in response to determining that the second distance is not less than the threshold, warping the second portion based on the predicted pose of the first electronic device;
while displaying the warped first portion at the second time, displaying the warped second portion at the second time.

6. The method of claim 1, wherein the first physical object has a current pose at the first time, wherein the current pose is different from the predicted pose at the second time, and wherein warping the first portion is based on a difference between the current pose and the predicted pose.

7. The method of claim 6, wherein the difference between the current pose and the predicted pose is characterized by a movement, the method further comprising decomposing the movement into a rotational component of the movement and a translational component of the movement.

8. The method of claim 7, wherein warping the first portion includes at least one of:
applying, to a rotational warping function, the first distance and the rotational component of the movement; and
applying, to a translational warping function, the first distance and the translational component of the movement.

9. The method of claim 8, wherein the rotational warping function is based on a distance between the center of the predicted pose and the first portion.

10. The method of claim 8, wherein performing the rotational warping function performing a spherical interpolation based on the first distance and the rotational component of the movement, and wherein performing the translational warping function includes performing a linear interpolation based on the first distance and the translational component of the movement.

11. The method of claim 7, wherein the rotational component of the movement is associated with a first threshold, and wherein the translational component of the movement is associated with a second threshold different from the first threshold.

12. The method of claim 1, wherein the first physical object corresponds to a second electronic device that is communicatively coupled with the first electronic device, wherein the first electronic device receives sensor data from the second electronic device, the method further comprising determining the predicted pose based at least in part on the sensor data.

13. The method of claim 1, wherein the first physical object corresponds to a user extremity, the method further comprising determining the predicted pose by performing computer vision with respect to the user extremity.

14. The method of claim 1, wherein the computer-generated object being positionally dependent on the first physical object includes anchoring the computer-generated object to the first physical object, and wherein warping the first portion includes shifting the first portion based on the predicted pose in order to maintain the anchoring.

15. The method of claim 1, wherein the computer-generated object is also positionally dependent on a second physical object, the method further comprising obtaining a predicted pose of the second physical object at the second time, wherein warping the first portion is further based on the predicted pose of the second physical object at the second time.

16. The method of claim 1, further comprising obtaining gaze data indicative of a gaze point, wherein warping the first portion is based on determining that the gaze region point is less than a threshold from the first portion.

17. The method of claim 1, further comprising obtaining a stencil that indicates portions of the computer-generated object that are to be warped and portions of the computer-generated object that are not to be warped, wherein warping the first portion is further based on the stencil.

18. A first electronic device comprising:
one or more processors;
a non-transitory memory; and
a display; and
one or more programs, wherein the one or more programs are stored in the
non-transitory memory and configured to be executed by the one or more processors, the one or more programs including instructions for:
rendering a computer-generated object at a first time, wherein the computer-generated object is positionally dependent on a first physical object;
obtaining a predicted pose of the first physical object at a second time, wherein the second time is after the first time;
warping a first portion of the computer-generated object based at least in part on a first distance between the predicted pose and the first portion; and
displaying, on the display at the second time, the warped first portion of the computer-generated object.

19. The first electronic device of claim 18, wherein a difference between a current pose of the first physical object at the first time and the predicted pose is characterized by a movement, wherein the one or more programs include instructions for:
decomposing the movement into a rotational component of the movement and a translational component of the movement;
applying, to a rotational warping function, the first distance and the rotational component of the movement; and
applying, to a translational warping function, the first distance and the translational component of the movement.

20. A non-transitory computer readable storage medium storing one or more programs, the one or more programs comprising instructions, which, when executed by a first electronic device with one or more processors and a display, cause the first electronic device to:
render a computer-generated object at a first time, wherein the computer-generated object is positionally dependent on a first physical object;
obtain a predicted pose of the first physical object at a second time, wherein the second time is after the first time;
warp a first portion of the computer-generated object based at least in part on a first distance between the predicted pose and the first portion; and
display, on the display at the second time, the warped first portion of the computer-generated object.
